(19) United States
(12) Patent Application Publication
(10) Pub. No.: US 2024/0393147 A1
(43) Pub. Date: Nov. 28, 2024

(54) POSITION SENSORS

(71) Applicant: SC2N, CRETEIL (FR)

(72) Inventors: Albin Le Sergent, CERGY PONTOISE (FR); Emeric Aussedat, CERGY PONTOISE (FR); Philippe Couasse, CERGY PONTOISE (FR); Franck Menard, CERGY PONTOISE (FR)

(73) Assignee: SC2N, CRETEIL (FR)

(21) Appl. No.: 18/699,301

(22) PCT Filed: Sep. 21, 2022
(86) PCT No.: PCT/EP2022/076184

§ 371 Date: Apr. 8, 2024

(30) Foreign Application Priority Data
Oct. 8, 2021 (FR) FR2110662

(51) Int. Cl. G01D 11/24; G01D 5/20

(52) U.S. Cl. CPC G01D 11/245; G01D 5/20

(57) ABSTRACT

An inductive-technology position sensor for an electric machine is disclosed. The position sensor is formed by a casing and a sensitive element disposed in the casing. The casing includes a cover and a connector from which at least one connection cable extends. The connector includes an element for retaining the connection cable.

The present invention relates to an inductive-technology position sensor. This sensor is intended to measure the position of a rotating element, for example of a rotor with respect to a stator, of an electric machine used in a mobility machine of the electric vehicle or electrically-assisted bicycle type.

This type of sensor requires the use of a connection cable that, during the assembly and fastening of the sensor in the motor environment of the mobility machine, requires the fastening of the cable to, for example, the motor and/or the use of additional pieces.

The fastening of this cable is all the more complicated in vehicle motors, in which the sensor has to be positioned near an electrical element or member of the motor generating a large magnetic field such as an alternator, a motor, a reduction gear, or high-intensity electrical cables used, for example, for hybrid vehicles.

The object of the present invention is therefore to overcome one or more of the drawbacks of the assemblies of the prior art by proposing an improved position sensor.

For this purpose, the present invention proposes an inductive-technology position sensor for an electric machine, formed by a casing and a sensitive element disposed in the casing, the casing having a cover and a connector from which at least one connection cable extends, the sensor having an element for retaining the connection cable.

This retention element makes it possible to channel the cables and to make the integration of the sensor easier.

According to one embodiment of the invention, the retention element is disposed on the cover on the outside of the sensor.

According to one embodiment of the invention, the retention element is formed by a non-closed, i.e. open, channel in which the cable or cable harness is disposed.

The insertion of the cable into this non-closed channel is thus made easier. According to one embodiment of the invention, the channel is rectilinear or in the shape of a wave.

According to one embodiment of the invention, the retention element is formed by at least one clip.

This makes it possible to hold the cable correctly.

According to one embodiment of the invention, the retention element is formed by a non-closed channel and at least one clip.

According to one embodiment of the invention, the retention element is formed from the cover.

This avoids the use of an additional piece.

According to one embodiment of the invention, the retention element is overmolded from the cover.

The invention also relates to an electric machine having a sensor assembly according to the invention.

The invention also relates to the use of the sensor according to the invention.

Further aims, features and advantages of the invention will be better understood and will become more clearly apparent upon reading the description given below with reference to the appended figures, which are given by way of example and in which:

FIG. 1 is an external view of the sensor according to the invention,

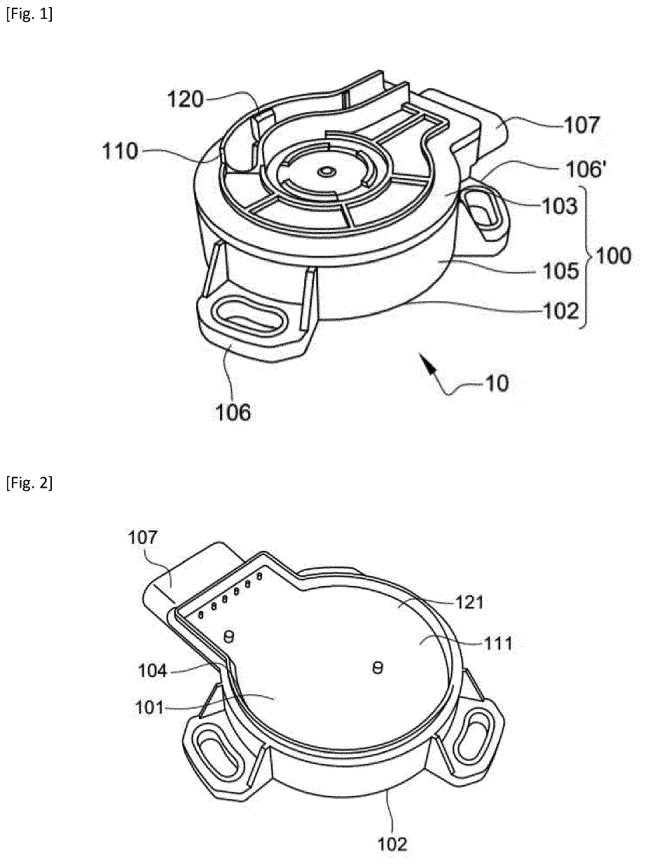

FIG. 2 is a view of the inside of the sensor according to one embodiment of the invention,

FIG. 3 is an external view of the sensor according to one embodiment of the invention,

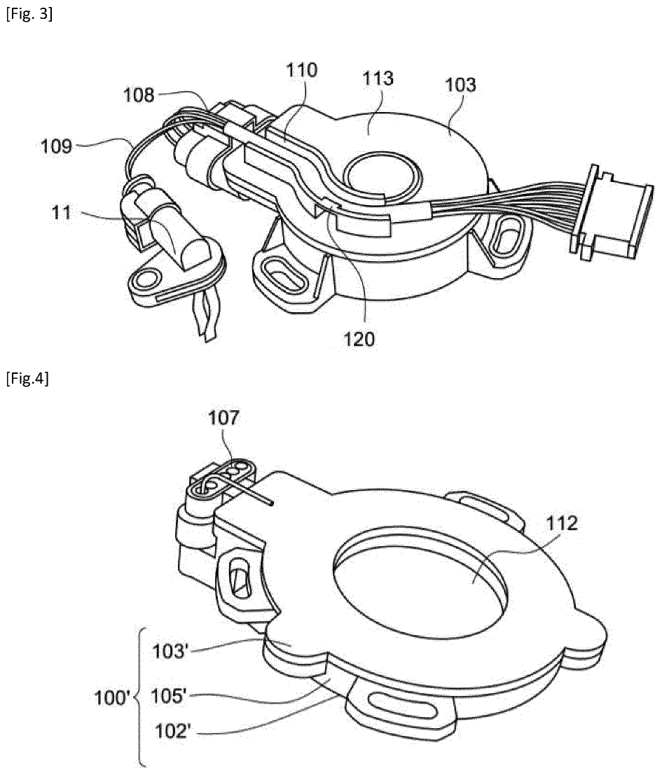

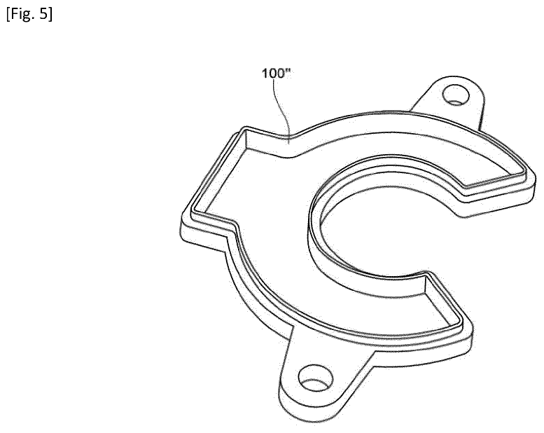

FIG. 4 is an external view of the sensor according to another embodiment of the invention,

FIG. 5 is an external view of the sensor according to another embodiment of the invention.

The invention relates to a position sensor 10 intended to be used with an electric machine or an element of the transmission of a mobility machine. More specifically, the position sensor 10 is an inductive-technology sensor, for measuring the position of a rotating element, for example of a rotor with respect to a stator of an electric machine.

As illustrated in [FIG. 1], the sensor 10 according to the invention is formed by a casing 100. In the context of the invention, a casing 100 is an element for example of the box, receptacle or envelope type enclosing the sensitive element of the sensor. More specifically, the casing has walls, a cover and a base if necessary, between which is disposed at least the sensitive element.

In the context of the invention, the sensitive element, illustrated in [FIG. 2], is formed by at least one printed circuit board (PCB) 101 disposed in the casing 100.

According to one embodiment of the invention, the board 101 is placed at the bottom 102 of the casing 100.

The bottom 102 is defined so as to be opposite the position of a cover 103 that makes it possible to close an opening 104 of the casing that is situated in a plane parallel to that of the bottom 102. The bottom 102 and the opening 104 are separated by the walls 105 of the casing.

The casing 100 is closed by a cover 103 also called a cap 103. The board 101 is thus disposed between the bottom 102 and the cover 103.

According to one embodiment of the invention, the board 101 has at least one transmitting antenna 111 and at least one receiving antenna 121.

During the use thereof, the board 101 having the antennae 111, 121 is thus placed facing a mobile target disposed on a rotating element so as to be able to determine the position of the rotating element.

In the context of the invention, the rotating element is the rotor of the electric machine. According to one embodiment of the invention, the casing 100 illustrated is a casing 100 made of plastic material. According to another embodiment of the invention, the casing 100 is made of any material allowing it to be integrated in a gearbox or motor environment, i.e. in an environment with high temperatures and difficult conditions.

According to one embodiment of the invention, the casing 100 has a connector 107. This connector 107 makes it possible to connect the sensor to a control or command element, for example of the inverter type, via at least one first connection cable 108. According to one embodiment of the invention, the sensor 10 has a harness 108 of connection cables. According to one embodiment of the invention, the connector 107 is fastened irreversibly to the connection cable 108. This means that it cannot be detached.

According to one embodiment of the invention, the connector 107 is detachable from the connection cable 108.

According to one embodiment of the invention, the casing 100 has at least one element 106, 106′ allowing the fastening thereof. This element 106, 106′ has the shape of a lug having an opening.

According to one embodiment of the invention, the fastening element 106, 106′ is an element for indexing the sensor on, for example, the electric machine. This makes it possible to correctly position the sensor relative to the mobile target.

According to an embodiment of the invention illustrated in [FIG. 4], the sensor 10 has a central opening 112. The opening is made from the cover 103 as far as the bottom 102 of the casing 100. The sensor thus forms a ring positioned around the shaft of the electric machine. Such a configuration makes the integration of the sensor easier.

According to an embodiment of the invention illustrated in [FIG. 5], the sensor 10 is in the shape of a C 100″. This means that it has the shape of an open ring. Such a configuration allows easier insertion of the sensor onto the shaft.

According to one embodiment of the invention, the inductive-technology sensor is associated with a temperature sensor 11 having a second connection cable 109.

In the context of the invention, the sensor 10 has an element 110 for retaining at least one connection cable 108 illustrated in [FIG. 1] and [FIG. 3]. More specifically, the retention element 110 is disposed on the cover 103 on the outside of the sensor 10, at the face 103 opposite the one oriented toward the sensitive element 101.

This retention element makes it possible to channel the cables and to make the integration of the sensor easier.

According to one embodiment, when the inductive sensor is associated with a temperature sensor 11, the retention element 110 also allows the retaining of the second connection cable 109.

According to one embodiment of the invention, the retention element 110 is formed by a non-closed channel in which the cable or cable harness is disposed. The channel is rectilinear or in the shape of a wave.

According to one embodiment of the invention, the retention element 110 is formed by at least one clip making it possible to retain at least one cable 108 by clip-fastening.

According to one embodiment of the invention, the retention element 110 is formed by a non-closed channel and at least one clip 120.

According to one embodiment of the invention, the retention element 110 is formed from the cover 103, i.e. it forms a single piece with the cover 103. This avoids the use of an additional piece.

According to one embodiment of the invention, the retention element 110 is overmolded from the cover 103, and this makes the manufacture thereof easier.

According to one embodiment of the invention, the retention element 110 is disposed on the cover so as to direct the cables from the connector as far as the end opposite the one at which the connector 107 is situated.

The invention also relates to the use of the position sensor 10 in an electric machine used in a mobility machine of the electric vehicle or electrically-assisted bicycle type.

The scope of the present invention is not limited to the details given above and allows embodiments in numerous other specific forms without moving away from the field of application of the invention. Consequently, the present embodiments should be considered to be by way of illustration, and can be modified without, however, departing from the scope defined by the claims.

1. An inductive-technology position sensor for an electric machine,
wherein the position sensor is formed by a casing and a sensitive element disposed in the casing,
the casing comprising a cover and a connector from which at least one connection cable extends,
wherein the position sensor comprises an element for retaining the connection cable.

2. The position sensor as claimed in claim 1,
wherein the retention element is disposed on the cover on the outside of the sensor.

3. The position sensor as claimed in claim 1,
wherein the retention element is formed by a non-closed channel in which the cable or cable harness is disposed.

4. The position sensor as claimed in claim 3,
wherein the channel is rectilinear or in the shape of a wave.

5. The position sensor as claimed in claim 1,
wherein the retention element is formed by at least one clip.

6. The position sensor as claimed in claim 1,
wherein the retention element is formed by a non-closed channel and at least one clip.

7. The position sensor as claimed in claim 1,
wherein the retention element is formed from the cover.

8. The position sensor as claimed in claim 1,
wherein the retention element is overmolded from the cover.

9. An electric machine comprising a sensor assembly as claimed in claim 1.

10. A gearbox comprising an inductive-technology position sensor as claimed in claim 1.
